(19) United States
(12) Patent Application Publication
(10) Pub. No.: US 2026/0040169 A1
(43) Pub. Date: Feb. 5, 2026

(54) METHODS FOR ACTIVATING PRE-CONFIGURED CELL CONFIGURATIONS USING MEDIUM ACCESS CONTROL (MAC) CONTROL ELEMENTS (CE)

(71) Applicant: InterDigital Patent Holdings, Inc., Wilmington, DE (US)

(72) Inventors: Brian Martin, Farnham (GB); Oumer Teyeb, Montreal (CA); Martino Freda, Laval (CA); Paul Marinier, Brossard (CA); Keiichi Kubota, Setagaya-Ku (JP)

(73) Assignee: InterDigital Patent Holdings, Inc., Wilmington, DE (US)

(21) Appl. No.: 18/997,362

(22) PCT Filed: Aug. 2, 2023
(86) PCT No.: PCT/US2023/071484

§ 371 Date: Jan. 21, 2025

Related U.S. Application Data
(60) Provisional application No. 63/395,072, filed on Aug. 4, 2022.
(60) Provisional application No. 63/410,404, filed on Sep. 27, 2022.

(51) Int. Cl. H04W 36/08; H04B 7/06; H04W 76/20; H04W 80/02

(52) U.S. Cl. CPC H04W 36/08; H04B 7/06968; H04W 76/20; H04W 80/02

(57) ABSTRACT

A wireless transmit/receive unit (WTRU) may receive a radio resource control (RRC) message comprising configuration information. The configuration information may include one or more preconfigured candidate cell configurations. Each of the preconfigured candidate cell configurations may include a special cell (SpCell) configuration, a secondary cell (SCell) configurations, and/or a candidate cell index. The WTRU may receive a medium access control (MAC) control element (CE). The MAC CE may indicate to apply a first preconfigured candidate cell configuration of the one or more preconfigured candidate cell configurations and an activation state for each SCell in the first preconfigured candidate cell configuration. The WTRU may initiate a handover to a SpCell in the first preconfigured candidate cell configuration based on the indication in the MAC CE. The WTRU may transmit data to the SCells activated by the MAC CE.

### CROSS-REFERENCE TO RELATED APPLICATIONS

This application claims priority to U.S. Provisional Patent Application No. 63/395,072, filed Aug. 4, 2022, and U.S. Provisional Patent Application No. 63/410,404, filed Sep. 27, 2022, the disclosures of which are incorporated herein by reference in their entireties.

### BACKGROUND

L1/L2 based mobility may include inter-cell beam management in intra-distributed unit (DU) and intra-frequency scenarios. In this case, the serving cell remains unchanged (e.g., there is no possibility to change the serving cell using L1/2 based mobility). In frequency range 2 (FR2) deployments, carrier aggregation (CA) may be used to exploit the available bandwidth, e.g., to aggregate multiple control channels (CCs) in one band. These CCs may be transmitted with the same analog beam pair (e.g., gNB beam and/or WTRU beam). The WTRU may be configured with transmission configuration indicator (TCI) states (for reception of physical downlink control channel (PDCCH) and/or physical downlink shared channel (PDSCH). The number of TCI states may be fairly large (e.g., 64). Each TCI state may include a reference signal (RS) and/or synchronization signal block (SSB). The WTRU may refers to this TCI for setting its beam. The SSB may be associated with a non-serving physical cell identification (PCI). Medium access control (MAC) signaling (e.g., TCI state indication for WTRU-specific PDCCH medium access control (MAC) control element (CE)) may activate the TCI state for a Coreset/PDCCH. Reception of PDCCH from a non-serving cell may be supported by MAC CE indicating a TCI state associated to non-serving PCI. MAC signaling (e.g., TCI states activation/deactivation for WTRU-specific PDSCH) may activate a subset of (e.g., up to) 8 TCI states for PDSCH reception. DCI may indicate which of the 8 TCI states to activate. A unified TCI state with a different updating mechanism (e.g., DCI-based) may be provided with multi-transmission/reception point (TRP).

### SUMMARY

Methods and/or apparatuses are provided for activating pre-configured cell configurations using medium access control (MAC) control element (CE). Methods and/or apparatuses may provide for L1/L2 based inter-cell mobility. Methods and apparatuses may provide for a downlink MAC CE for controlling simultaneous special cell (SpCell) and/or secondary cell (Scell) change. Methods and/or apparatuses may provide for two stage activation of serving cells, where an initial command activates target cell measurement(s) and/or a second command activates a handover and/or switch. Methods and/or apparatuses may provide for network confirmation of WTRU determined cell set.

A WTRU may receive a radio resource control (RRC) message comprising a candidate cell list. The WTRU may perform one or more handover preparation procedures associated with one or more SCells and/or candidate cells on the candidate cell list. The one or more handover preparation procedures may include one or more of performing measurements associated with one or more target SpCells), obtaining timing advance information for the one or more target SpCells, and/or starting tracking beams on the one or more target SpCells. The WTRU may receive a MAC CE. The MAC CE may indicate a first SpCell (e.g., a current SpCell) and one or more second SpCells. The first SpCell may be a current SpCell. The one or more second SpCells may be target SpCells. The MAC CE may comprise one or more target SpCell indexes that indicate the one or more second SpCells associated with a handover. The WTRU may monitor one or more handover conditions for the one or more second SpCells. The one or more handover conditions may include one or more of a timer, a measurement threshold, and/or a beam failure detection. The measurement threshold may be associated with a radio link monitoring (RLM) measurement. The WTRU may send a reconfiguration complete message to a target SpCell (e.g., of the one or more target SpCells) upon fulfillment of the one or more handover conditions.

A WTRU may receive a radio resource control (RRC) message comprising configuration information. The configuration information may include one or more preconfigured candidate cell configurations. Each of the preconfigured candidate cell configurations may include one or more of a special cell (SpCell) configuration, a secondary cell (SCell) configurations, and/or a candidate cell index. The WTRU may receive a medium access control (MAC) control element (CE). The MAC CE may indicate to apply a first preconfigured candidate cell configuration of the one or more preconfigured candidate cell configurations and an activation state for each SCell in the first preconfigured candidate cell configuration. The WTRU may initiate a handover to a SpCell in the first preconfigured candidate cell configuration based on receipt of the MAC CE. The WTRU may transmit data to the SCells activated by the MAC CE.

The WTRU may determine whether to activate the SCells in the first preconfigured candidate cell configuration based on the activation state indicated in the MAC CE.

The MAC CE may indicate a transmission configuration indicator (TCI) state for one or more cells in the first preconfigured candidate cell configuration. The MAC CE may comprise a flag that indicates whether to apply the first preconfigured candidate cell configuration as a master cell group (MCG) and/or a secondary cell group (SCG). The MAC CE may comprise a flag that indicates whether to apply the first preconfigured candidate cell configuration corresponding to a previously reported index.

The MAC CE may be a first MAC CE. The WTRU may be further configured to receive a second MAC CE that activates the first preconfigured candidate cell configuration indicated in the first MAC CE. The MAC CE may be a first MAC CE. The WTRU may be further configured to receive a second MAC CE, wherein the second MAC CE initiates target SpCell measurements. The WTRU may be further configured to receive a second MAC CE that indicates which SpCells in the first preconfigured candidate cell configuration with which to initiate a SpCell handover.

The handover may be a conditional handover to a plurality of SpCells. The conditional handover may be based on one or more radio quality measurements of the plurality of SpCells and the first preconfigured candidate cell configuration.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example handover scenario.

FIG. 3 depicts an example conditional handover configuration and/or execution procedure.

FIG. 4 depicts an example L1/L2 inter-cell mobility operation.

FIG. 5 depicts an example medium access control (MAC) control element (CE) coding.

FIG. 6 depicts an example operation of special cell (SpCell) and secondary cell (SCell) switching using the MAC CE.

FIG. 7 depicts an example MAC CE coding with an additional bit.

FIG. 8 depicts an example MAC CE coding with additional octets.

FIG. 9 depicts an example MAC CE coding having a single octet.

FIG. 10 depicts another example MAC CE coding.

FIG. 11 depicts another example MAC CE coding.

### DETAILED DESCRIPTION

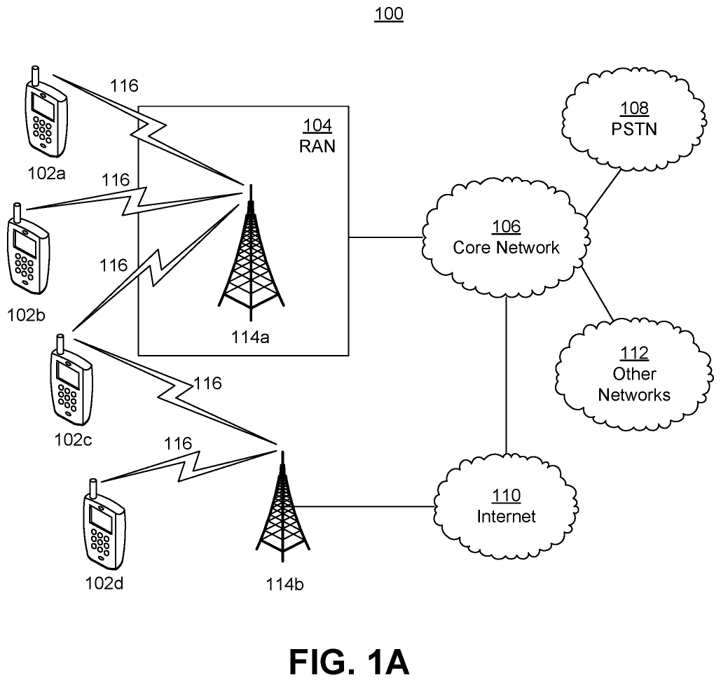

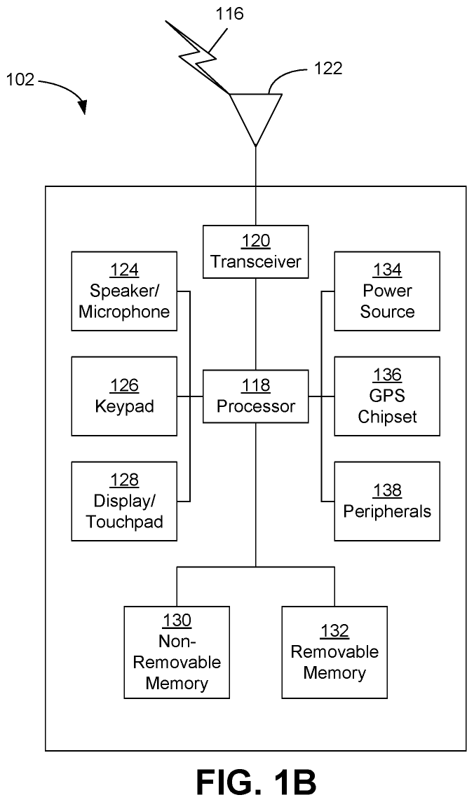

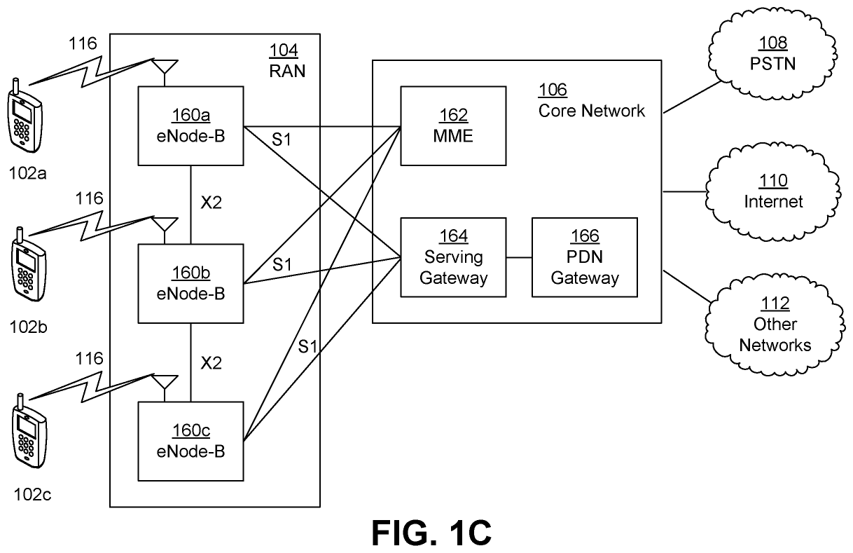

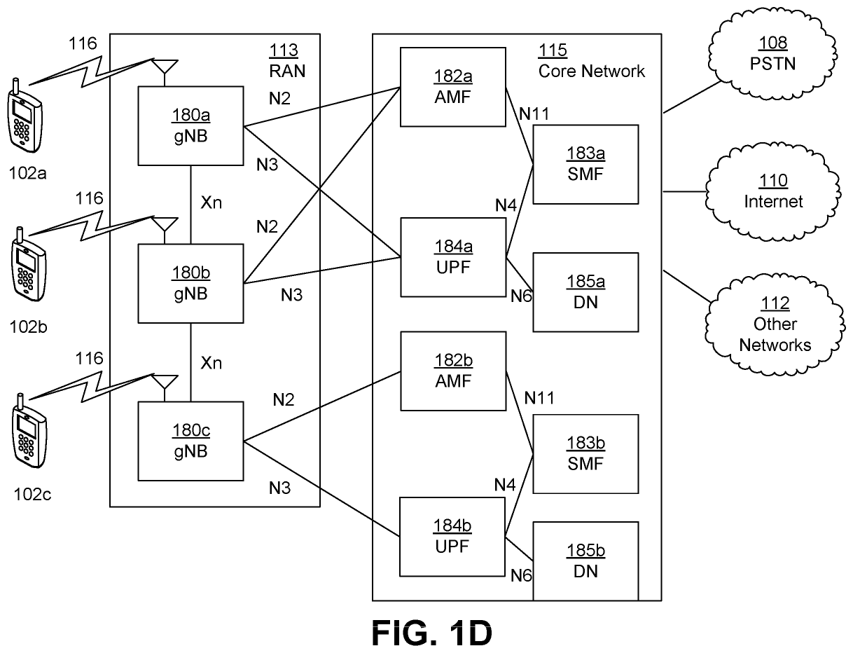

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with one or more of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement

MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include one or more of AMF 182a, 182b, one or more of UPF 184a, 184b, one or more Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

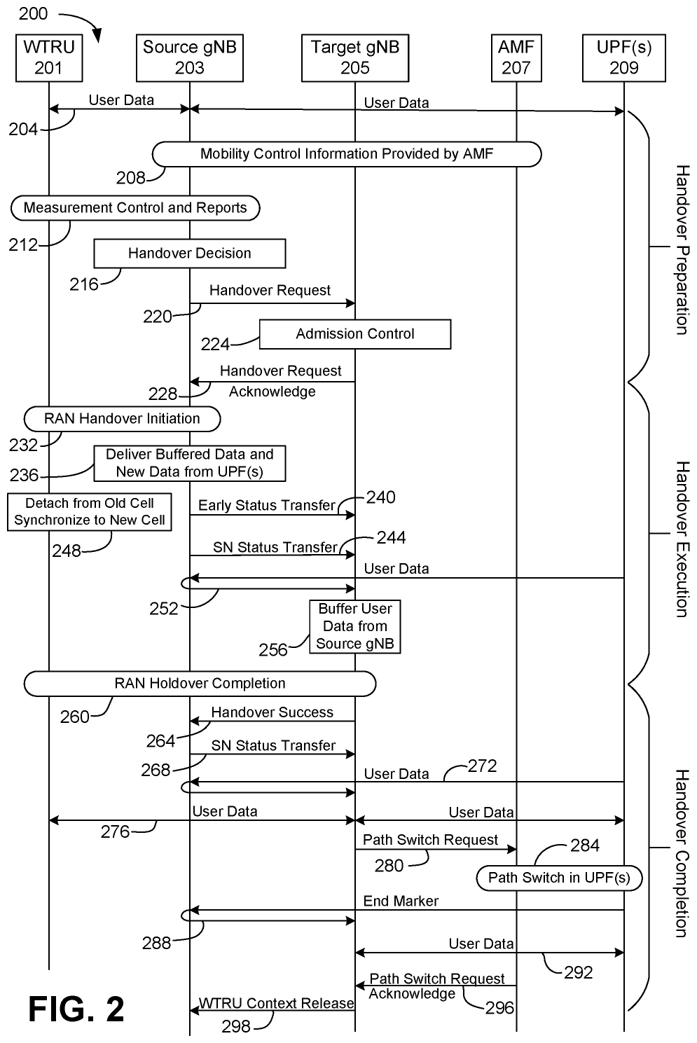

FIG. 2 depicts an example handover scenario 200. At 204, a WTRU context within a source gNB 203 may include user data and/or information regarding roaming and/or access restrictions which were provided, e,g. either at connection establishment and/or at the last timing advance (TA) update. At 208, the source gNB 203 and/or target gNB 205 may configure the mobility information provided by an access and mobility management function (AMF) 207. At 212, the source gNB 203 may configure the WTRU measurement control(s), procedure(s) and/or the WTRU report(s), e.g., according to a measurement configuration. At 216, the source gNB 203 may determine to handover the WTRU 201 based on, e.g., the received measurement(s). At 220, the source gNB 203 may send a Handover Request message to the target gNB 205. The handover request message may include a transparent RRC container with necessary information to prepare the handover at the target side. The information may include one or more of the target cell ID, KgNB*, the cell radio network temporary identifier (C-RNTI) of the WTRU 201 in the source gNB 203, RRM-configuration including WTRU inactive time, basic AS-configuration including antenna Info and DL Carrier Frequency, the current QoS flow to DRB mapping rules applied to the WTRU 201, the SIB1 from source gNB 203, the WTRU capabilities for different random access technologies (RATs), protocol data unit (PDU) session related information, and/or the WTRU reported measurement information including beam-related information if available.

At 224, admission Control may be performed by the target gNB 205. If the WTRU 201 can be admitted, the target gNB 205 may prepare the handover with L1/L2. At 228, the target gNB 205 may send a handover acknowledgement (ACK) (e.g., such as a HANDOVER REQUEST ACKNOWLEDGE) to the source gNB 203. The handover ACK may include a transparent container to be sent to the WTRU 201 as an RRC message to perform the handover. At 232, the source gNB 205 may trigger the Uu handover by sending an RRCReconfiguration message to the WTRU 201. The RRCReconfiguration message may include the information required to access the target cell: at least the target cell ID, the new C-RNTI, and/or the target gNB 205 security algorithm identifiers for the selected security algorithms. The RRCReconfiguration message, sent at 232, may also include a set of dedicated random access channel (RACH) resources, the association between RACH resources and SSB(s), the association between RACH resources and WTRU-specific channel state information reference signal (CSI-RS) configuration(s). common RACH resources, and/or system information of the target cell, etc.

At 244, the source gNB 203 may send an SN STATUS TRANSFER message to the target gNB 205 to convey, for example, the UL packet data convergence protocol (PDCP) SN receiver status and/or the downlink PDCP SN transmitter status of data radio barriers (DRB(s)) for which PDCP status preservation applies (e.g., for radio link control (RLC) acknowledgment mode (AM)). The SN STATUS TRANSFER procedure may transfer the uplink PDCP SN and/or HFN receiver status and/or the downlink PDCP SN and/or HFN transmitter status. The transfer may occur from either the source to the target NG-RAN node during an Xn handover, between the NG-RAN nodes involved in dual connectivity, and/or after retrieval of a WTRU context for RRC reestablishment. The transfer may occur for each respective DRB of the source DRB configuration for which PDCP SN and HFN status preservation applies. At 248, the WTRU 201 may synchronize to the target cell and/or complete the RRC handover procedure by sending RRCReconfigurationComplete message to the target gNB 205. At 252, the UPF 209 may end user data to the source gNB 203 and/or the target gNB 205 (e.g., via the source gNB 203). At 256, the target gNB 203 may buffer user data received from the source gNB. At 260, the WTRU 201, the source gNB 203, and/or the target gNB 205 may complete the RAN holdover. At 264, the target gNB 205 may indicate to the source gNB 203 that the handover was successful. At 268, the source gNB 203 may indicate an SN status transfer to the target gNB 205. At 272, the UPF 209 may send user data to the source gNB 203 and/or the target gNB 205 (e.g., via the source gNB 203). At 276, the target gNB 205 may communicate user data with the WTRU 201 and/or the UPF 209.

At 280, the target gNB 205 may send a PATH SWITCH REQUEST message to the AMF 207, for example, to trigger the core network (e.g., 5GC) to switch the DL data path towards the target gNB 205 and/or to establish a next generation control plane (NG-C) interface instance towards the target gNB 205. At 284, the core network may switch the DL data path towards the target gNB 205. At 288, the UPF 209 may send one or more “end maker” packets on the old path to the source gNB 203 per PDU session and/or tunnel. The UPF 209 may then release, at 288, any U-plane and/or transport network layer (TNL) resources towards the source gNB 203. At 292, the target 205 handles the user data. At 296, the AMF 207 may confirm the PATH SWITCH REQUEST message with the PATH SWITCH REQUEST ACKNOWLEDGE message. At 298, upon reception of the PATH SWITCH REQUEST ACKNOWLEDGE message from the AMF 207, the target gNB 205 may send a UE CONTEXT RELEASE message to the source gNB 203. The target gNB 205 may send the UE CONTEXT RELEASE message to, for example, inform the source gNB 203 about the success of the handover. The source gNB 203 may then (e.g., based on receipt of the UE CONTEXT RELEASE message) release radio and/or C-plane related resources associated to the WTRU context (not pictured in FIG. 2). Any ongoing data forwarding may continue.

Conditional handover (CHO) and conditional Primary Secondary Serving Cell (PSCell) Addition/Change (CPA/CPC, or collectively referred to as CPAC) may be provided. CHO and/or CPAC may reduce the likelihood of radio link failures (RLF) and/or handover failures (HOF).

Legacy handover may typically be triggered by measurement reports, even though there is nothing preventing the network from sending a handover (HO) command to the WTRU even without receiving a measurement report. For example, the WTRU is configure with an A3 event that triggers a measurement report to be sent when the radio signal level/quality (RSRP, RSRQ, etc) of a neighbor cell becomes better than the Primary serving cell (PCell) or also the PSCell, in the case of Dual Connectivity (DC). The WTRU may monitor the serving and/or neighbor cells and may send a measurement report when one or more conditions are fulfilled. When such a report is received, the network (e.g., current serving node/cell) may prepare the HO command (e.g., such as an RRC Reconfiguration message, with a reconfiguration With Sync). The network may send the HO command to the WTRU. The WTRU may execute (e.g., immediately execute) the HO, resulting in the WTRU connecting to the target cell.

Conditional handover (CHO) may include preparing multiple handover targets (e.g., as compared to only one target in a legacy HO). The WTRU may not immediately execute the CHO as in the case of the legacy handover. For example, the WTRU may be configured with one or more triggering conditions (e.g., a set of radio conditions). The WTRU may execute the handover towards one of the targets when/if the one or more triggering conditions are fulfilled.

The CHO command may be sent when the radio conditions towards the current serving cells are still favorable. Sending the CHO command under favorable conditions may 19nitiatieg the two main points of failure in legacy handover: the failure to send the measurement report (e.g., if the link quality to the current serving cell falls below acceptable levels when the measurement reports are triggered in normal handover) and the failure to receive the handover command (e.g., if the link quality to the current serving cell falls below acceptable levels after the WTRU has sent the measurement report, but before it has received the HO command).

The triggering conditions for a CHO may be based on the radio quality of the serving cells and/or neighbor cells (e.g., like the conditions that are used in legacy NR/LTE to trigger measurement reports). For example, the WTRU may be configured with a CHO that has an A3 like triggering conditions and associated HO command. The WTRU may monitor the current and serving cells. When the A3 triggering conditions are fulfilled, the WTRU may execute the associated HO command and/or switch its connection towards the target cell (e.g., instead of sending a measurement report).

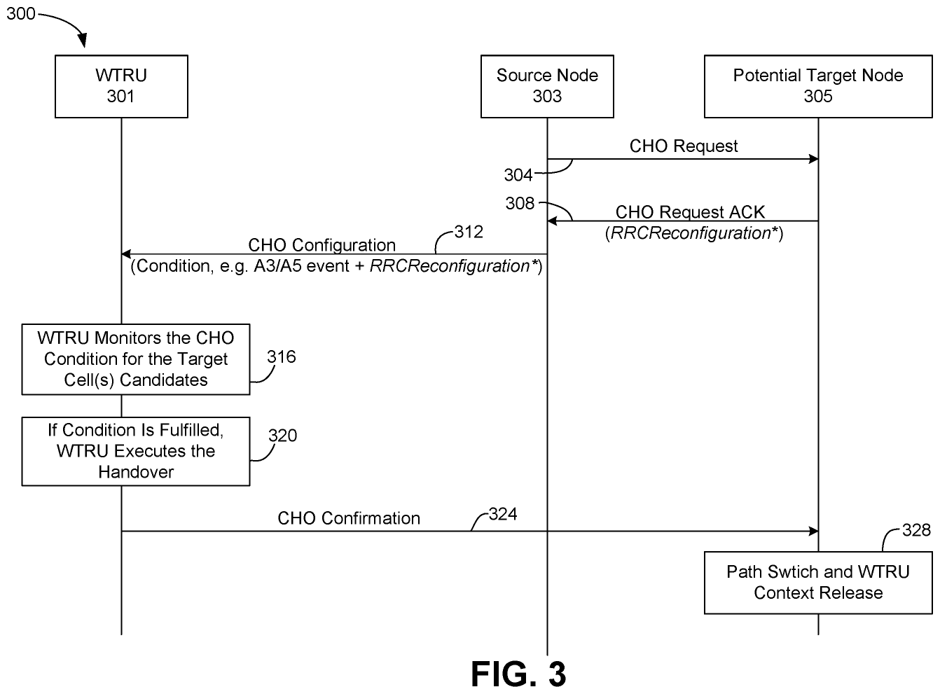

FIG. 3 depicts an example conditional handover configuration and/or execution procedure 300. At 304, the example CHO configuration and execution procedure may include a source node 303 sending a CHO request to one or more target nodes 305. At 308, the one or more target nodes 305 may respond with a CHO request ACK. At 312, the source node 303 may send a CHO configuration message to a WTRU 301. At 316, the WTRU 301 may monitor one or more CHO conditions of the target nodes 305. At 320, when a condition is fulfilled, the WTRU 301 may execute the HO. At 324, the WTRU 301 may send a CHO confirmation message to the target node 305. At 328, the target node 305 may perform a path switch and/or WTRU 301 context release.

CHO may prevent unnecessary re-establishments in case of RLF. For example, a WTRU may be configured with multiple CHO targets. In that case, the WTRU may experience a RLF before the triggering conditions act to fulfil any of the targets. Legacy HO operation may result in an RRC re-establishment procedure that may incur considerable interruption time for the bearers of the WTRU. With a CHO, if the WTRU, after detecting an RLF, ends up a cell for which it has an associated CHO (e.g., the target cell is already prepared for the CHO), the WTRU may execute the HO command associated with this target cell directly (e.g., instead of continuing with a full re-establishment procedure).

CPC and/or CPA may be extensions of CHO in dual connectivity (DC) scenarios. A WTRU may be configured with triggering conditions for PSCell change and/or addition. When the triggering conditions are fulfilled, the WTRU may execute the associated PSCell change and/or PSCell add commands.

Inter-cell L1/L2 mobility may be used to manage the beams in CA. L1/L2 based inter-cell mobility may support mobility latency reduction. L1/L2 based inter-cell mobility may include configuration and/or maintenance for multiple candidate cells, for example, to allow fast application of configurations for candidate cells. L1/L2 based inter-cell mobility may include dynamic switch mechanism(s) among candidate serving cells (e.g., including SpCell and/or SCell), for example, for the potential applicable scenarios based on L1/L2 signalling. L1/L2 based inter-cell mobility may include one or more L1 enhancements for inter-cell beam management, (e.g., L1 measurement and/or reporting, and/or beam indication). L1/L2 based inter-cell mobility may include Timing Advance management. L1/L2 based inter-cell mobility may include centralized unit-distributed unit (CU-DU) interface signaling to support L1/L2 mobility, if needed.

L1/L2 based inter-cell mobility may be applicable to Standalone, CA and NR-DC case with serving cell change within one cell group (CG). L1/L2 based inter-cell mobility may be applicable to intra-DU case and intra-CU inter-DU case (e.g., applicable for Standalone and/or CA). L1/L2 based inter-cell mobility may be applicable to both intra-frequency and inter-frequency. L1/L2 based inter-cell mobility may be applicable to both frequency range 1 (FR1) and frequency range 2 (FR2). L1/L2 based inter-cell mobility may be applicable when source and target cells are synchronized or non-synchronized. L1/L2 based inter-cell mobility may be applicable when an inter-CU case is not included.

L1/L2 based mobility may include inter-cell beam management in intra-DU and intra-frequency scenarios. In this case the serving cell remains unchanged (e.g., there is no possibility to change the serving cell using L1/L2 based mobility). In FR2 deployments, carrier aggregation (CA) may be used in order to exploit the available bandwidth, e.g., to aggregate multiple control channels (CCs) in one band. These CCs may be transmitted with the same analog beam pair (e.g., gNB beam and/or WTRU beam). The WTRU may be configured with transmission configuration indicator TCI states for reception of physical downlink control channel (PDCCH) and/or physical downlink shared channel (PDSCH). Each TCI state may include a reference signal (RS) and/or synchronization signal block (SSB) that the WTRU refers to for setting its beam. The SSB may be associated with a non-serving physical cell identification (PCI). Medium access control (MAC) signaling (e.g., TCI state indication for WTRU-specific PDCCH medium access control (MAC) control element (CE)) may activate the TCI state for a Coreset/PDCCH. Reception of PDCCH from a non-serving cell may be supported by MAC CE indicating a TCI state associated to non-serving PCI. MAC signaling (e.g., TCI states activation/deactivation for WTRU-specific PDSCH) may activate a subset of (e.g., up to) 8 TCI states for PDSCH reception. DCI may indicate which of the 8 TCI states to activate. A unified TCI state with a different updating mechanism (e.g., DCI-based) may be provided with multi-transmission/reception point (TRP).

When using a conventional L3 handover or a conditional handover the WTRU may send a measurement report using RRC signalling. In response to the measurement report, the network may provide a further measurement configuration and/or a CHO configuration. With a conventional HO the network may provide a configuration for a target cell after the WTRU reports using RRC signalling that the cell meets a configured radio quality criteria. With a CHO, the network may provide, in advance, a target cell configuration and/or a measurement criteria which determines when the WTRU should trigger the CHO configuration (e.g., in order to reduce the HO failure rate due to the delay in sending a measurement report then receiving an RRC reconfiguration). Both CHO and conditional HO may suffer from some amount of delay, for example, due to the sending of measurement reports and/or receiving of target configurations, particularly in case of the conventional (non-conditional) HO.

L1/L2 inter-cell mobility may improve HO latency compared to a conventional L3 HO or a conditional handover. L1/L2 based inter-cell mobility may enable a fast application of configuration(s) for candidate cells, including, e.g., dynamically switching between SCells and/or switching of the PCell (e.g., switch the roles between SCell and PCell) without performing RRC signalling. L1/L2 based inter-cell mobility may not support the inter-CU case, for example, as this requires relocation of the PDCP anchor. An RRC based approach may support inter-CU handover.

In examples, legacy L3 handover mechanisms may include releasing active SCell(s) before the WTRU completes the handover to a target cell in the coverage area of a new site. The active SCell(s) may (e.g., may only) be added back after a successful HO. This may lead to throughput degradation during handover. L1/L2 based inter-cell mobility may enable CA operation to be enabled instantaneously upon serving cell change.

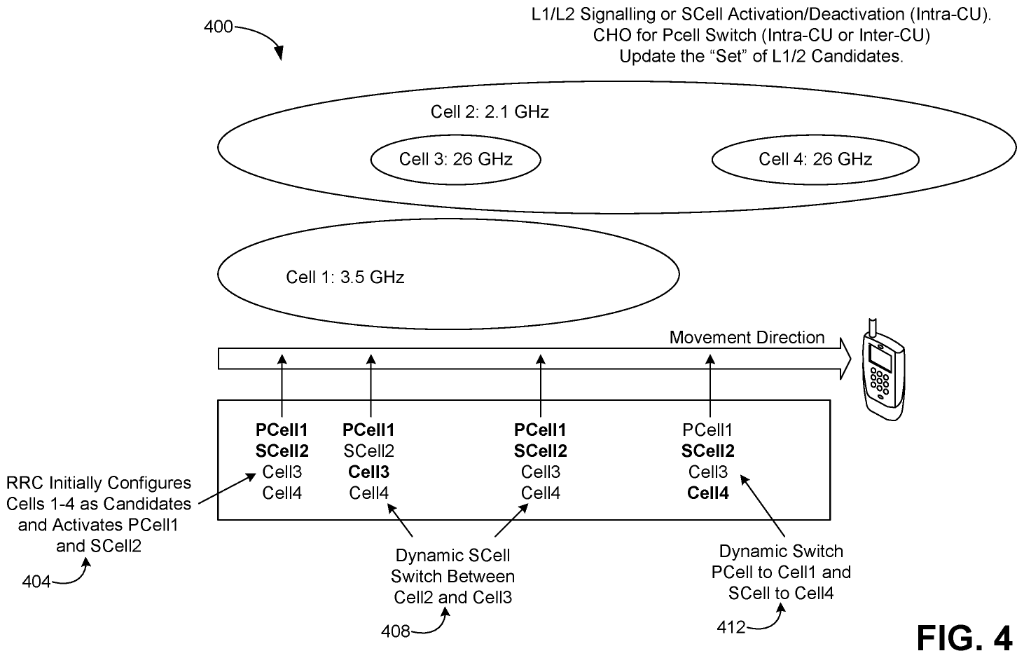

FIG. 4 depicts an example of L1/L2 inter-cell mobility operation 400. At 404, in the example L1/L2 inter-cell mobility operation 400, a candidate cell group may be configured by RRC and/or a dynamic switch of PCell and/or SCell. At 408, a dynamic switch of PCell and/or SCell may be achieved using L1/L2 signalling.

At 412, to perform fast switching between cells, and in particular SpCells (e.g., PCell and/or PSCell), pre-configuration of the candidate cells at the RRC layer may be performed. In examples, the configuration may be applied upon receiving an indication from L1/L2. Candidate cells may have one or more of an SpCell configuration and/or an SCell configuration. The SpCell configuration and/or the SCell configuration may be dynamically applied based on an indication at lower layers.

Additional configuration(s) associated with the preconfigured SCell and/or SpCells may be provided. For example, measurement configurations, and/or configurations assigned to candidate cells in order that at least one of synchronization, TA management, inter-cell beam management, RLM, and/or BFD procedures may be performed before and/or during the reconfiguration.

The pre-configurations in RRC may need to be referenced, for example, in an efficient way to minimize the signalling required to perform the switching.

AWTRU may be configured to receive an RRC message comprising a candidate cell list. The WTRU may perform one or more HO preparation procedures associated with one or more SCells or candidate cells on the candidate cell list. The one or more HO preparation procedures may include one or more of performing measurements associated with one or more target SpCells, obtaining timing advance information for the one or more target SpCells, and/or starting tracking beams on the one or more target SpCells. The WTRU may receive a medium access control (MAC) control element (CE). The MAC CE may indicate a first SpCell and one or more second SpCells. The first SpCell may be a current SpCell. The one or more second SpCells may be target SpCells (e.g., the one or more target SpCells). The MAC CE may comprise a target SpCell index that indicates the one or more second SpCells associated with a HO. The WTRU may monitor one or more HO conditions for the one or more second SpCells. The one or more HO conditions may include one or more of a timer, a measurement threshold, and/or a beam failure detection (BFD). The measurement threshold may be associated with a radio link monitoring (RLM) measurement. The WTRU may send a reconfiguration complete message to a target SpCell (e.g., of the one or more target SpCells) upon fulfillment of the one or more HO conditions.

Cell switching may be signalled using a MAC CE (e.g., to improve the reliability of the cell switching command). Compared to using L1 signalling such as DCI, the MAC CE may be transmitted using HARQ. Transmitting using HARQ may improve the reliability of transmission by reducing the possibility of losing the downlink control command over the air.

A MAC CE may include information which references the index of the RRC configuration(s) of the cell(s) configured (e.g. activated) and/or reconfigured (e.g. change of role from SCell to SpCell) as the current serving cell(s) and/or cell(s) involved in a specific part of the L1/L2 mobility procedure. The MAC CE may reference the index of the cell(s), provide an indication of their current role, and/or indicate an activation state of the cell(s). The index of the cell(s) and/or the indication of their current role may identify the configuration(s) to apply and/or which configuration(s) to release.

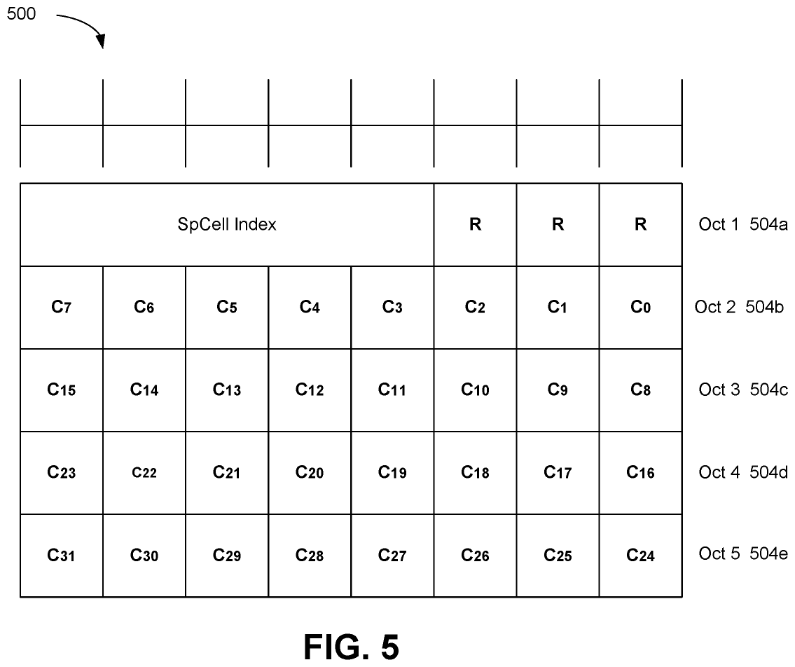

FIG. 5 depicts an example MAC CE coding 500. The network may send the MAC CE 500 to a WTRU. Before receiving the MAC CE 500, the WTRU may receive configuration information from the network. In the example MAC CE coding 500, the network may first pre-configure a list of cells (e.g., up to 32) using RRC signalling with an SCell configuration and/or an SpCell configuration and an index. For example, a WTRU may receive an RRC message that includes the configuration information. The configuration information may include one or more preconfigured candidate cell configurations. Each preconfigured candidate cell configuration may include an SpCell configuration, an SCell configuration, and/or a candidate cell index.

The MAC CE 500 may indicate to apply one of the preconfigured candidate cell configurations. For example, the MAC CE 500 may indicated which of the preconfigured candidate cell configurations to apply. The MAC CE 500 may indicate an activation state (e.g., such as activated or deactivated) for each SCell in the indicated preconfigured candidate cell configuration. Each of the 32 cells may be identified in the preconfigured candidate cell configuration using 1 of the 32 bits in octets 2 to 5 504b-e, and may be configured, activated, and/or deactivated as SCells using this bitmap (e.g., the candidate cell index). The integer “1” may indicate that a cell is activated as a serving cell. The integer “0” may indicate that a candidate is deactivated as a serving cell. A specific cell may be identified using the SpCell index in octet 1 504a (e.g., a value between 0 and 31). Although the remaining 3 bits are shown as reserved, these bits may be defined for a specific purpose (e.g. to enable enhancements in a future release such as conditional L1/2 cell switching, inter-CU reconfiguration, or to indicate specific scenarios such as NR-DC and/or DAPs handover).

The combination of an integer value for an SpCell index, followed by a bitmap identifying SCells may be an efficient coding method to perform both SCell activation deactivation and SpCell change using a single MAC CE. For example, the WTRU may initiate a handover to an SpCell in the indicated preconfigured candidate cell configuration (e.g.,in the SPCell Index) based on the MAC CE 500. The WTRU may be configured to transmit data to the SCells activated by the MAC CE 500. For example, the WTRU may determine whether to activate the SCells in the indicated preconfigured candidate cell configuration based on the activation state(s) indicated in the MAC CE 500. As described herein, the MAC CE 500 may indicate a TCI state for one or more cells in the indicated preconfigured candidate cell configuration.

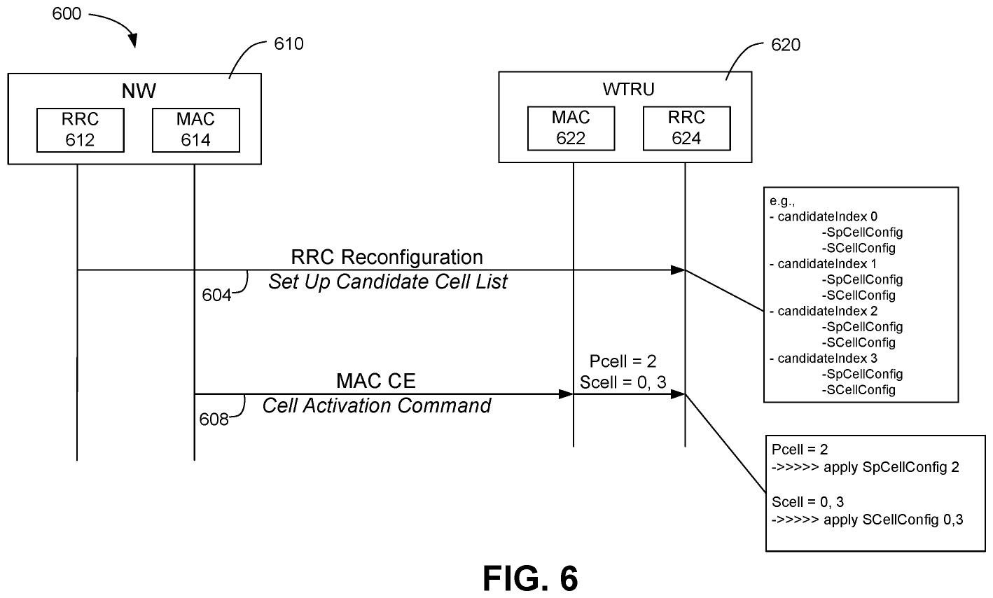

FIG. 6 depicts an example operation 600 of SpCell and/or SCell switching using the MAC CE. The network 610 may have an RRC layer 612 and a MAC layer 614. The WTRU 620 may have a MAC layer 622 and an RRC layer 624. An SpCell switch may be also known as a handover. If the SpCell is the PSCell, it may be known as an SCG change. The SpCell may be changed using RRC signalling. The RRC may perform one or more procedures such as, e.g., releasing the current SpCell configuration, deriving new security keys, applying a new SpCell configuration, resetting counters, indicating to lower layers flush buffers (e.g., perform MAC reset) and/or the like. The WTRU 620, after applying the new SpCell configuration, may complete the handover by sending a reconfiguration complete message to the new SpCell. The RRC procedure for performing and/or completing the reconfiguration may remain unchanged. Additional enhancements may be made to further optimize the reconfiguration procedure (e.g., use of a MAC CE to indicate handover completion, and/or implicit handover completion based on decoding of a first uplink and/or downlink transmission and/or reception).

At 604, initiating an RRC reconfiguration may include a change of SpCell, and SCell(s) simultaneously using configurations provided in advance using RRC signalling and activated using a MAC CE. The RRC reconfiguration may work both with the existing RRC reconfiguration procedures and/or with enhanced RRC (e.g., MAC and/or RLC, etc.) procedures. For example, the network 610 may send the RRC reconfiguration from its RRC layer 612 to the RRC layer 624 of the WTRU 620. In addition to dynamically initiating a handover (SpCell change) and perform SCell change (e.g., activation/deactivation), a relatively large (e.g., up to 32) number of cells may be configured with preconfigured SpCell and/or SCell configurations, and/or activate a limited number of cells as serving cells (e.g., up to 8). At 608, a truncated version of many of the existing MAC CEs may be used for regular operation. For example, SCell activation and/or deactivations, power headroom reporting (PHR), and/or beam failure recovery (BFR) have truncated versions which may be used advantageously instead of the full version in reduce resources. For example, the SCell part of the MAC CE may not activate and/or deactivate SCells. The SCell part of the MAC CE may inform the WTRU 620 which of the candidate cells may be treated as SCells, and which are not. For example, the network 610 may send, at 608, a cell activation command from its MAC layer 614 to the MAC layer 622 of the network 620. Those candidate cells configured as SCells may then be subject to a separate activation and/or deactivation.

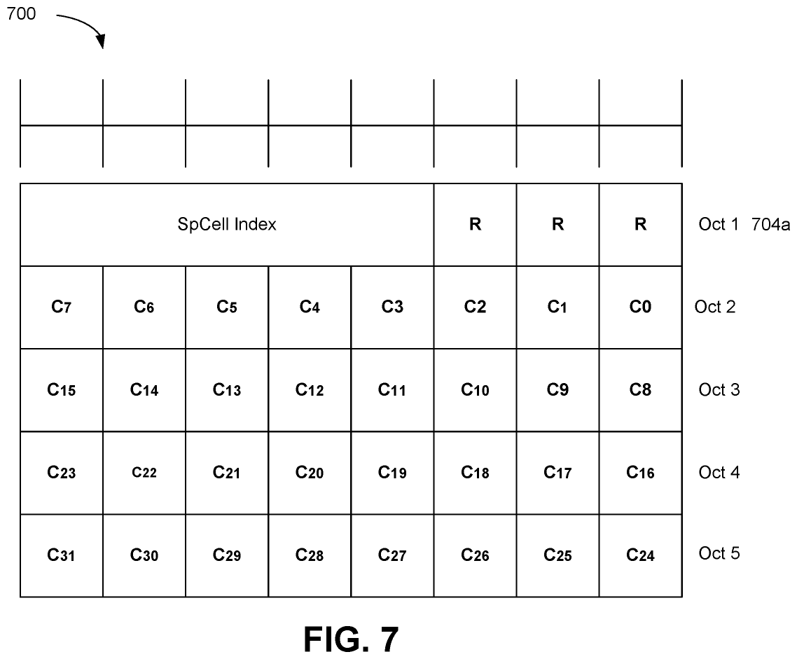

FIG. 7 depicts an example MAC CE coding 700 with an additional bit. The MAC CE coding 700 may be further optimized, for example, by re-interpreting the 32 bits used to reference SCells. The MAC CE coding 700 may include first considering the cell (e.g., or configuration) indicated in the SpCell index field to not be included in the SCell list.

The example MAC CE coding 700 may include using one further bit for another purpose (e.g., when compared to the MAC CE coding 500 shown in FIG. 5). Since one of the cells is indicated as a PCell, that cell may not also be an SCell. Therefore, the PCell index may be removed from the bitmap and/or the remaining (e.g., only the remaining) 31 cells may be referenced. The PCell may have (e.g., always have) index 0, and SCells may have (e.g., always have) indexes 1-31. In the example MAC CE coding 700, the indexes may be renumbered from PCell index+1 to 32, to PCell index to 31, for example, to correctly interpret the MAC CE and/or identify the correct RRC configurations to apply.

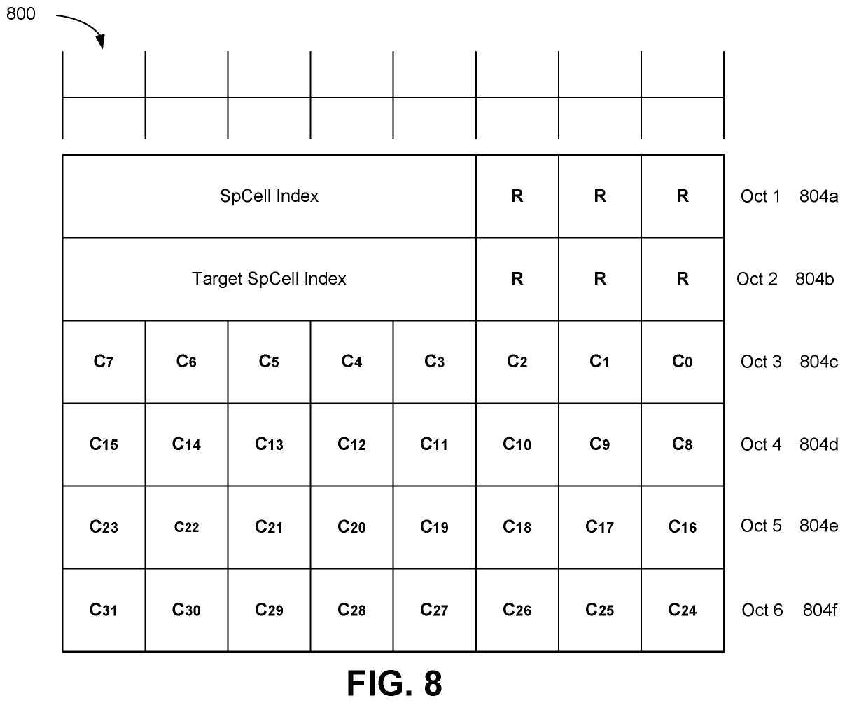

FIG. 8 depicts another example MAC CE coding 800 with additional octets. The MAC CE 800 may include one or more additional octets 804a-f (e.g., when compared to the MAC CE 800 shown in FIG. 5). In examples, the one or more octets 804a-f may indicate one or more target SpCell index(es). The target SpCell may be indicated prior to activating a cell change to, e.g., perform some handover preparation steps. The handover preparation steps may include starting to perform measurements (such as RLM, and/or BFD), synchronizing to the target cell in advance of handover, obtaining timing advance information for the target ahead of cell switching, and/or starting tracking beams on the target cell. One or more of the handover preparation steps may be activated before switching the SpCell, to, e.g., improve latency and/or reliability of the cell switch itself. The MAC CE 800 may provide an indication of one or more transmission configuration indicator (TCI) states associated with the target cell to perform measurements (e.g., inter-cell beam management, uplink synchronization, and/or other procedures). For example, the MAC CE 800 may indicate a TCI state for one or more cells in a preconfigured candidate cell configuration.

In examples, both the current SpCell and/or a target SpCell may be indicated when switching to a new SpCell while activating radio link monitoring and/or other handover preparation steps on a new SpCell.

In examples, the SpCell index may not need to be provided. The MAC CE may provide (e.g., only provide) a target SpCell index, and possibly one or more target or current SCells. In this case, the WTRU may not activate any SpCell switch immediately. Rather, the WTRU may initiate the handover preparation steps, e.g., the one or more procedures described above.

In examples, one bit (e.g., one of the R bits) may indicate whether the MAC CE command corresponds to a master cell group (MCG) (e.g., PCell and/or SCells) and/or a secondary cell group (SGC) (e.g., PSCell, SCell).

In examples, the index of the SpCell of the MCG and/or the SpCell of the SCG may be included in the same command.

An indication of the target SpCell may require one or more conditions to activate the SpCell change (e.g., conditional handover). The one or more conditions may include, for example, a procedural condition, a timer, and/or a measurement condition (e.g., a conditional handover may be configured). The WTRU may start evaluating the trigger condition(s) upon receiving the relevant target SpCell indication in the MAC CE. The handover may be initiated when the condition(s) is/are fulfilled. For example, a WTRU may initiate a handover based on one or more radio quality measurements of SpCells in a preconfigured candidate cell configuration.

The one or more conditions may include a second MAC CE, which indicates an “activation” command, such as “activate the configuration indicated in the previous MAC CE”. For example, upon receiving the target PCell indication, the WTRU may start performing and/or reporting measurements. The network may activate the cell change when the reported measurements are determined by the network to be suitable for performing the cell change.

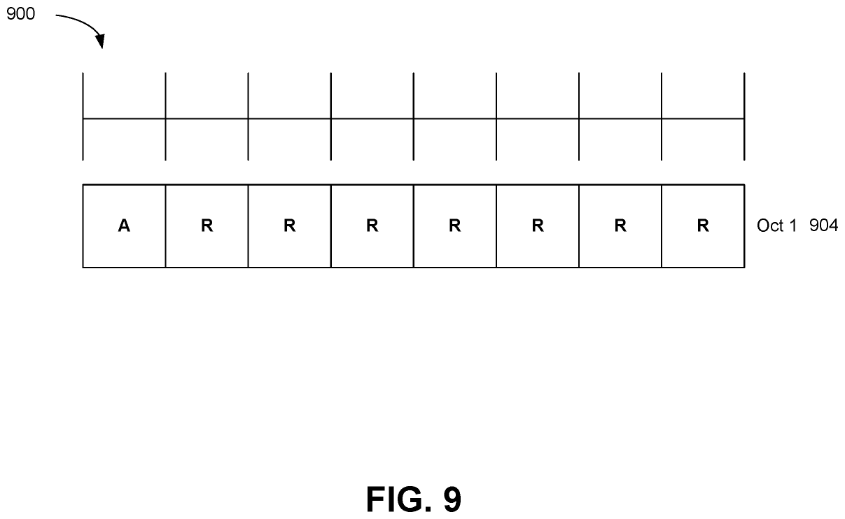

FIG. 9 depicts another example MAC CE coding 900 having a single octet. The activation MAC CE may be a single octet 904, which may include a single activation bit as shown in FIG. 9. The activation MAC CE may include multiple bits indicating one of several previously activated configurations.

The activation at MAC may be performed in 2 stages. A first activation stage may include receiving an activation MAC CE is received at the WTRU indicating a target configuration, for example, a target SpCell. A second activation stage may include the activation MAC CE activating the cell changes. For example, the network may first activate N target SpCells using a first MAC CE. The network may then confirm which of those N target SpCells to perform a SpCell change to using N bits in a second MAC CE.

In examples, the activation MAC CE may confirm a WTRU selection of a target configuration. For example, the WTRU may be configured with measurements. For example, the WTRU may report a list of one or more best cells (e.g., using an RRC measurement report, some L1 measurement reporting, and/or in an uplink MAC CE). The activation may refer to the reported list of cells and the WTRU may initiate an SpCell change using the stored RRC configuration to the previously reported best cell.

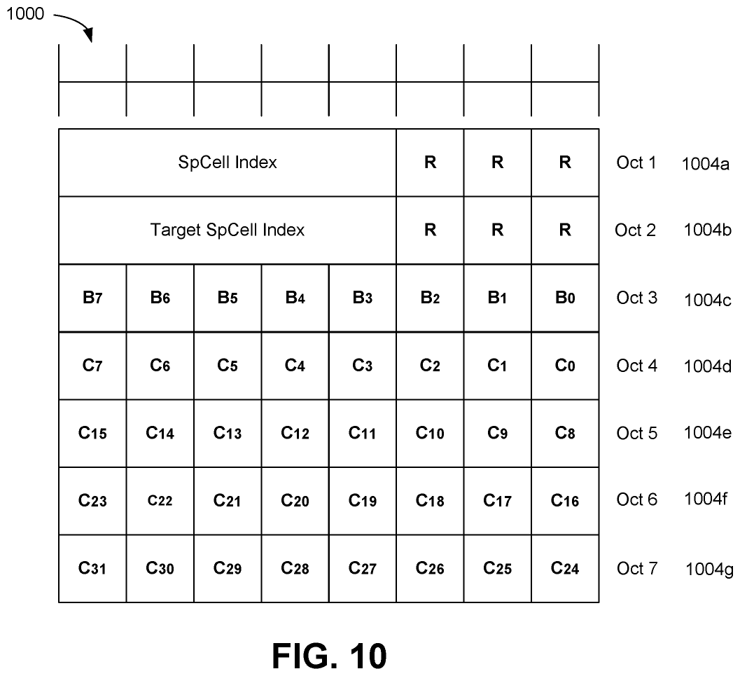

FIG. 10 depicts another example MAC CE coding 1000. The MAC CE coding 1000 may include an SpCell index, a target SpCell index, and/or 32 bits, as described herein. The MAC CE coding 1000 may include one or more octets 1004a-g to indicate some further configuration.

In examples, the additional one or more octets 1004a-g may inform the WTRU which SCells to activate and/or deactivate. The 32 bits (e.g., labelled “C” in FIG. 10) may indicate which of the candidate cells to treat as SCells. In this example, the maximum number of serving cells may be 8 (e.g., 1 SpCell and 7 SCells) of a possible 32 candidates. The additional one or more octets 1004a-g may indicate which of the 7 SCells to activate/deactivate. The additional one or more octets 1004a-g may inform the WTRU of any other candidate cell role. For example, the additional one or more octets may inform the WTRU of which cells to use for L1 inter-cell beam management procedures (e.g., the possibility to perform beam management procedures on a cell other than the current SpCell), which cells to perform RLM, and/or the like.

In examples, one or more candidate cell configurations may include one or more cell group configurations, (e.g.,using the IE CellGroupConfig). The candidate cell configuration may include one or more RRC Reconfigurations (e.g., an using RRC Reconfiguration message). For example, the candidate cell configuration may include one or more cell group configurations and/or RRC Reconfigurations when candidate cells belong to different DUs (e.g., in which case a new cell group configuration may be needed as the new cell group configurations may include DU specific information, such as RLC and/or MAC configurations) and/or CUS (e.g., in which case the RRC Reconfiguration may be used). For example, RRC Reconfiguration may include CU specific information, such as, e.g., PDCP and/or SDAP configurations, and/or measurement configurations.

In examples, the MAC CE triggering a cell change may point to a cell group configuration and/or a full RRC reconfiguration. In this case, an explicit index may be provided (for example similar to octet 1 in FIG. 7 but, for example, where the index points to a cell group index or a full configuration index rather than an SpCell index). The pre-configured candidate configuration may include the necessary information, for example, including the serving cells (e.g., the SpCell and SCells to configure when the Cell group is activated).

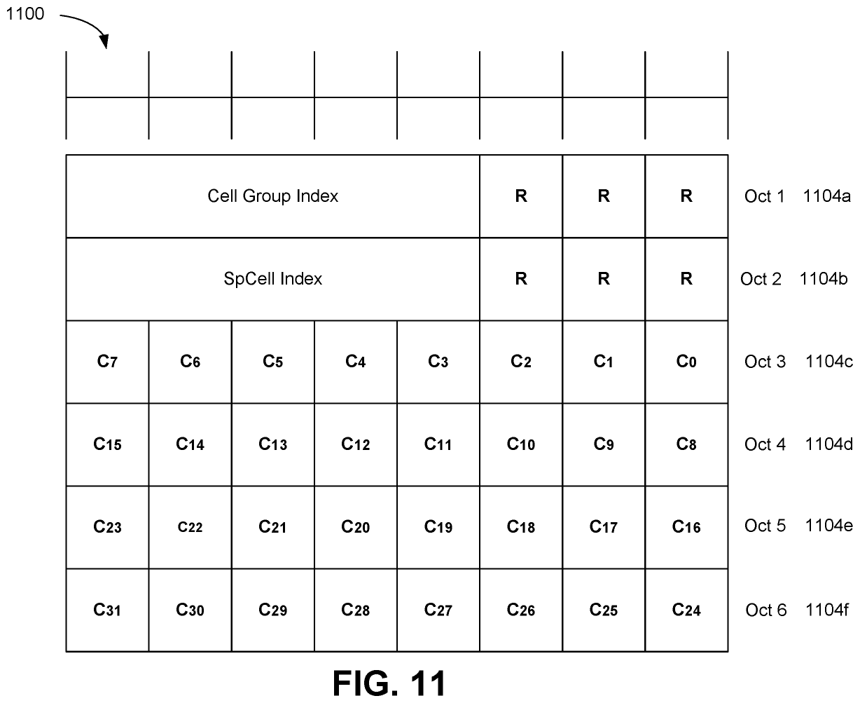

In examples, the MAC CE may indicate a cell group index and/or a full configuration index. In some examples, the MAC CE may additionally or alternatively specify which cells to include. For example, a cell group (e.g., corresponding to a particular DU) may be preconfigured and/or associated to multiple potential target cells (e.g., belonging to that DU). The MAC CE may indicate the cell group and the cell to configure as SpCell, for example, as well as the cell(s) to configured as SCells. An example encoding is provided in FIG. 11.

FIG. 11 depicts another example MAC CE coding 1100. The MAC CE coding 1100 may include the cell group index provided in octet 1 1104a, the SpCell index provided in octet 2 1104b, and/or octets 3-6 1104c-f may be used to indicate which SCells to configure as part of the cell group.

In some examples, the network may provide a MAC CE including an RRC Reconfiguration index if the CU changes, a MAC CE including a cell group index if the DU changes, and/or a MAC CE including candidate cell index(es) (e.g., only candidate cell index(es)) if the cell changes but, for example, not the CU and/or DU. The type and/or the content of the MAC CE issued to the WTRU may be used to determine whether to perform intra-DU (e.g., no cell group change) procedures (e.g., no MAC reset), inter-DU (e.g., cell group may be changed) procedures (e.g., MAC reset and/or RLC re-establishment), and/or inter-CU (e.g., full RRC reconfiguration or RB configuration may be changed) procedures (e.g., PDCP re-establishment, security refresh).

The MAC CE coding 1100 may combine a current SpCell (e.g., PCell, PSCell), a target SpCell (e.g., PCell, PSCell), one or more SCells, activation and/or deactivation of the one or more SCells, and/or an indication of which cells belong to a group of cells for which additional requirements apply in a single command. Alternatively or additionally, the MAC CE coding 1100 may combine a target cell group configuration, a target RRC Reconfiguration, a target DU, and/or a target CU.

1.-40. (canceled)

41. A wireless transmit/receive unit (WTRU) comprising a processor and a memory, the processor configured to:
receive a radio resource control (RRC) message comprising configuration information, the configuration information comprising one or more preconfigured candidate cell configurations, wherein each of the preconfigured candidate cell configurations comprises a special cell (SpCell) configuration, one or more secondary cell (SCell) configurations, and a candidate cell index;
receive a medium access control (MAC) control element (CE), wherein the MAC CE comprises a target configuration identifier (ID), and an indication of one or more transmission configuration indicator (TCI) states wherein the target configuration ID indicates a target SpCell associated with both of the one or more preconfigured candidate cell configurations and a candidate cell index, and the indication of one or more TCI states is associated with the target SpCell;
initiate a handover to the target SpCell based on the target configuration ID; and
activate the one or more TCI states associated with the target SpCell.

42. The WTRU of claim 41, wherein each of the one or more preconfigured candidate cell configurations further comprises an activation state for each SCell associated with each of the one or more SCell configurations.

43. The WTRU of claim 42, the processor further configured to:
activate the one or more SCells associated with the one or more SCell configurations based on the activation state indicated in the one or more preconfigured candidate cell configurations comprised in the RRC message.

44. The WTRU of claim 41, the processor configured to:
send an RRC reconfiguration complete message to the target SpCell after receiving the MAC CE.

45. The WTRU of claim 41, wherein the MAC CE further comprises a downlink TCI state ID associated with each of the one or more TCI states, wherein the downlink TCI state ID indicates an activation of one or more downlink TCI states associated with the target SpCell.

46. The WTRU of claim 41, wherein the MAC CE further comprises an uplink TCI state ID associated with each of the one or more TCI states, wherein the uplink TCI state ID indicates an activation of one or more uplink TCI states associated with the target SpCell.

47. The WTRU of claim 41, wherein the indication of one or more TCI states associated with the target SpCell comprises a beam associated with each TCI state.

48. The WTRU of claim 41, the processor further configured to:
initiate the handover to the target SpCell after selecting the target SpCell while a timer is running

49. The WTRU of claim 41, wherein the MAC CE is a first MAC CE that does not activate at least one SCell in a first preconfigured candidate cell configuration of the one or more preconfigured candidate cell configurations, the WTRU further configured to receive a second MAC CE that activates the at least one SCell of the first preconfigured candidate cell configuration of the one or more preconfigured candidate cell configurations indicated in the first MAC CE.

50. The WTRU of claim 41, wherein the MAC CE is a first MAC CE, the WTRU further configured to receive a second MAC CE, wherein the second MAC CE initiates measurements of at least one SCell.

51. A method implemented by a wireless transmit/receive unit (WTRU), the method comprising:
receiving a radio resource control (RRC) message comprising candidate configuration information, the configuration information comprising one or more preconfigured candidate cell configurations, wherein each of the preconfigured candidate cell configurations comprises a special cell (SpCell) configuration, one or more secondary cell (SCell) configurations, and a candidate cell index;
receiving a medium access control (MAC) control element (CE), wherein the MAC CE comprises a target configuration identifier (ID) and an indication of one or more transmission configuration indicator (TCI) states, wherein the target configuration ID indicates a target SpCell associated with both of the one or more preconfigured candidate cell configurations and a candidate cell index, and the indication of one or more TCI states is associated with the target SpCell;
initiating a handover to the target SpCell based on the target configuration ID; and
activating the one or more TCI states associated with the target SpCell.

52. The method of claim 51, wherein each of the one or more preconfigured candidate cell configurations further comprises an activation state for each SCell associated with each of the one or more SCell configurations.

53. The method of claim 52, further comprising:
activating the one or more SCells associated with the one or more SCell configurations based on the activation state indicated in the one or more preconfigured candidate cell configuration comprised in the RRC message.

54. The method of claim 51, further comprising:
sending an RRC reconfiguration complete message to the target SpCell after receiving the MAC CE.

55. The method of claim 51, wherein the MAC CE further comprises a downlink TCI state ID associated with each of the one or more TCI states, wherein the downlink TCI state ID indicates an activation of the one or more downlink TCI states associated with the target SpCell

56. The method of claim 51, wherein the MAC CE further comprises an uplink TCI state ID associated with each of the one or more TCI states, wherein the uplink TCI state ID indicates an activation of the one or more uplink TCI states associated with the target SpCell.

57. The method of claim 51, wherein the indication of one or more TCI states associated with the target SpCell comprises a beam associated with each TCI state.

58. The method of claim 51, further comprising:
initiating the handover to the target SpCell after selecting the target SpCell while a timer is running.

59. The method of claim 51, wherein the MAC CE is a first MAC CE that does not activate at least one SCell in a first preconfigured candidate cell configuration of the one or more preconfigured candidate cell configurations, the WTRU further configured to receive a second MAC CE that activates the at least one SCell of the first preconfigured candidate cell configuration of the one or more preconfigured candidate cell configurations indicated in the first MAC CE.

60. The method of claim 51, wherein the MAC CE is a first MAC CE, the WTRU further configured to receive a second MAC CE, wherein the second MAC CE initiates measurements of at least one SCell.
